(19) United States
(12) Patent Application Publication
(10) Pub. No.: US 2006/0222916 A1
(43) Pub. Date: Oct. 5, 2006

(54) Mehotd for determining a maximum power point voltage of a fuel cell, as well as fuel cell control system and power controller used in the fuel cell control system

(76) Inventors: Yasuaki Norimatsu, Hitachinaka (JP); Akihiko Kanouda, Hitachinaka (JP); Mutsumi Kikuchi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/354,920

(22) Filed: Feb. 16, 2006

(30) Foreign Application Priority Data
Mar. 31, 2005 (JP) 2005-104875

(51) Int. Cl. H01M 8/04; G05D 11/00

(52) U.S. Cl. 429/23; 700/286

(57) ABSTRACT

A detection voltage, which is obtained by dividing the voltage of a fuel cell 1 by resistors, is compared with a first reference voltage Vref1 by a differential amplifier. The differential voltage is input to a control section. The control section performs PWM control for the circuit section according to the difference. The first reference voltage Vref1 is set according to the dividing ratio of the resistors, based on the output voltage when the fuel cell generates power at the maximum power point. To determine the output voltage for maximum power generation, a characteristic curve representing a current-voltage characteristic is approximated by an approximating line within a range excluding an area in which the output voltage changes abruptly when the output current is nearly zero, and an extrapolated voltage is obtained on the extension line of the approximating line at an output current of zero. Fifty percent of the extrapolated voltage is then determined as the output voltage when the fuel cell generates power at the maximum power point. Thus, a fuel cell control system that identifies a highly precise output voltage for power generation at a maximum power point and controls power so that the maximum power point is not exceeded could be provided.

### CLAIM OF PRIORITY

The present application claims priority from Japanese application serial no. 2005-104875, filed on Mar. 31, 2004, the content of which is hereby incorporated by reference into this application.

### FIELD OF THE INVENTION

The present invention relates to a method for determining a maximum power point voltage of a fuel cell, as well as a fuel cell control system and a power controller used in the fuel cell control system.

### BACKGROUND OF THE INVENTION

Recent progress in electronic technology is rapidly making the widespread use of mobile electronic apparatus such as mobile telephones, notebook computers, audio-visual apparatus, and mobile terminals. Owing to development of active cell materials and high-capacity cell structures, secondary cells used as power supplies of these mobile electronic apparatus have evolved from conventional seal lead batteries to Li-ion batteries through Ni—Cd batteries and Ni-hydrogen batteries to increase their capacities.

Although efforts have been made for mobile electronic apparatus so that they consume less power and thus the power consumption of each function of a device has been greatly reduced, new functions need to be added to continue to meet increased user needs, so the total power consumption of a mobile electronic apparatus could be considered to increase more and more. This requires high-density power supplies, that is, power supplies that are compact and assure a long operation time.

Recently, fuel cells have attracted much attention as power supplies that meet the above requirement. As an output characteristic of a fuel cell, the output power increases as the output current increases, but the output power begins to decrease when the output voltage reaches a certain value. This means that there is a maximum power point in the output characteristic of a fuel cell at which power generation becomes the most efficient. If the fuel cell is used at a point exceeding the maximum power point, the power generation efficiency falls, resulting in insufficient output power. This may deteriorate the electrodes of the fuel cell.

As technology for controlling fuel cells, Japanese patent Laid-open No. 2003-229138, for example, proposes a fuel cell system in which an output voltage when the fuel cell generates power at the maximum power point is used as a voltage setting; when the detected output voltage of the fuel cell falls below the voltage setting, power is supplied from an auxiliary power means to the load so that the output voltage is kept at or above a preset voltage, thereby maintaining the output power of the fuel cell within the maxim power point.

Japanese patent Laid-open No. H07 (1995)-153474 discloses a fuel cell power generator that uses an upper voltage limit and lower voltage limit to control output power; the output voltage of the fuel cell is kept within a preset range by increasing the output current when the output voltage of the fuel cell exceeds the upper voltage limit and decreasing the output current when the output voltage falls below the lower voltage limit.

### SUMMARY OF THE INVENTION

In the technology described in the Japanese patent Laid-open No. 2003-229138, however, the voltage setting is determined by limiting the output voltage when the fuel cell generates power at the maximum power point (this output voltage is called the maximum power point voltage) to the range of 35% to 50% of the open-circuit voltage; this is problematic because, for some fuel cells, the output power cannot be limited to or below the maximum power point.

FIG. 12 shows output characteristics of a polymer electrolyte fuel cell (PEFC) and direct methanol fuel cell (DMFC) with the current density (A/cm²) on the horizontal axis and the output voltage (V) and power density (mW/cm²) on the vertical axis. Characteristic curve “a” indicates current-voltage characteristic of the direct methanol fuel cell, characteristic curve “b” indicates current-power density characteristic of the direct methanol fuel cell, and characteristic curve “c” indicates current-voltage characteristic of the polymer electrolyte fuel cell.

As for the direct methanol fuel cell, as indicated by characteristic curve “a”, the voltage range is from 0.8 V, which is the open circuit-voltage, to 0.2 V or below. From the viewpoint of a superior current-voltage characteristic, however, the range of voltages usable for actual power generation is 0.4 V or below. Furthermore, since the maximum power point voltage during power generation at the maximum power point Q is near 0.2 V, so the range of actually usable voltages is from 0.4 V to 0.2 V.

When the technology described in the Japanese patent Laid-open No. 2003-229138, for example, is applied to a direct methanol fuel cell having the characteristic described above, the maximum power point voltage is set to a voltage of 0.28 V or higher because the open circuit voltage is 0.8 V. As a result, the output voltage of the fuel cell is controlled to a voltage of 0.28 V or higher. In this case, as indicated by characteristic curve “b” that represents a current-power density characteristic, the output power greatly deviates from the maximum power point Q, resulting in the inability of the fuel cell to generate high-output power.

As for the polymer electrolyte fuel cell, as indicated by characteristic curve “c”, the open circuit voltage is 1 V and the range of usable voltages is from 0.95 V to 0.50 V.

If the technology described in the Japanese patent Laid-open No. 2003-229138, for example, is used to control the polymer electrolyte fuel cell, therefore, the maximum power point voltage is set to a voltage of 0.35 V or higher because the open circuit voltage is 1 V. As a result, the output voltage of the fuel cell is controlled to a voltage of 0.35 V or higher, which is outside the usable voltage range. This makes the fuel cell unable to generate power with high efficiency. In addition, a drop in output power may cause output power insufficiency and deteriorate the electrodes of the fuel cell.

Particularly, for a direct methanol fuel cell and other fuel cells the output voltage of which largely changes, a slight difference in output voltage may cause the output power to largely deviate from the maximum power point, so it is necessary to accurately set a voltage when power is generated at the maximum power point, that is, a maximum power point voltage. In the method based on the open circuit voltage as described in the Japanese patent Laid-open No. 2003-229138, however, large error may be produced for some fuel cells, and the maximum power point voltage may not be accurately set.

The output characteristic of the direct methanol fuel cell greatly changes according to the fuel cell temperature and the flow rate of the gas in the air pole, and the output power may fall abruptly for some reason, for example, when carbon dioxide, water, or another product resulting from a reaction clogs. When an abrupt drop in the output power occurs, the output current needs to be limited immediately. If the technology described in, for example, the Japanese patent Laid-open No. H07 (1995)-153474 is used to control the output current, the output current is increased and decreased in a step fashion; it is increased when the output voltage of the fuel cell exceeds the upper voltage limit and decreased when the output voltage falls below the lower voltage limit. Therefore, limitation of current cannot track an abrupt output voltage change as described above.

When the fuel cell temperature rises, the output voltage also increases. In control by the technology in the Japanese patent Laid-open No. H07 (1995)-153474, however, an increase in the output voltage further increases the output current, increasing the output voltage more and more.

The present invention addresses the above problem with the object of providing a maximum power point voltage determining method for accurately determining a maximum power point voltage of a fuel cell independently of its type as well as a fuel cell control system that can limit the output voltage to or below the maximum power point when the fuel cell generates power or a power controller that controls the fuel cell control system. Accordingly, the fuel cell control system or power controller can track abrupt drops in the output voltage and abrupt temperature changes.

In the maximum power point determination method according to the present invention, a characteristic curve representing a current-voltage characteristic is approximated by an approximating line within a range excluding an area in which the output voltage changes abruptly when the output current is nearly zero, an extrapolated voltage is determined on the extension line of the approximating line at an output current of zero, and the output voltage when the fuel cell generates power at the maximum power point is determined from the extrapolated voltage as the maximum power point voltage.

For example, the maximum power point voltage may be set to 50% of the extrapolated voltage.

The fuel cell control system according to the present invention has reference voltage generating means for generating a reference voltage and control means for comparing the output voltage of the fuel cell with the reference voltage and limiting the output power of the fuel cell when the output voltage is lower than the reference voltage; the reference voltage generating means regards the maximum power point voltage determined by the maximum power point voltage determination method as the minimum voltage and generates a reference voltage higher than the minimum voltage.

The control means can also limit the output power by comparing the temperature detection value of the fuel cell with a preset temperature value and restricting the elevation of the temperature when the temperature detection value of the fuel cell exceeds the preset temperature value.

The power controller according to the present invention has at least a voltage input terminal that can receive the output voltage of the fuel cell, a control terminal that outputs control signals to a control end of a power regulating source that regulates the output power of the fuel cell, a reference voltage generating source that generates a reference voltage, and a control signal generating means that compares the output voltage of the fuel cell that has been received at the voltage input terminal with the reference voltage generated by the reference voltage generating source, generates a control signal to limit the output power of the fuel cell so as to increase the output voltage of the fuel cell when the output voltage is lower than the reference voltage, and outputs the control signal to the control terminal; the reference voltage generating source regards the maximum power point voltage determined by the maximum power point voltage determination method as the minimum voltage and generates a reference voltage equal to or higher than the minimum voltage.

When a temperature terminal that can receive the temperature detection value of the fuel cell is further provided, the control signal generating means compares the temperature detection value received at the temperature terminal with a preset temperature value and generates the above control signal so as to reduce the output power of the fuel cell when the temperature detection value of the fuel cell exceeds the preset temperature value.

In the maximum power point determination method according to the present invention, an approximating line is used to approximate a characteristic curve representing a current-voltage characteristic, an extrapolated voltage is determined on the extension line of the approximating line at an output current of zero, and a maximum power point voltage is determined according to the extrapolated voltage, thereby enabling the maximum power point voltage to be determined according to the electric characteristic of the fuel cell. Since the maximum power point voltage of a fuel cell is determined regardless of its type and the output voltage of the fuel cell is controlled so that it is equal to or higher than the maximum power point voltage, the output power can be limited to an area not lower than the maximum power point.

The fuel cell control system determines the output voltage for power generation at the maximum power point by the determination method described above, sets the output voltage as the reference voltage, and controls the output power of the fuel cell when the output voltage of the fuel cell is lower than the reference voltage; so even in case of a reduction in the output power, the output voltage is always kept to or above the output voltage when power is generated at the maximum power point. As a result, fuel cell power generation at a point exceeding the maximum power point never occurs. In addition, when the output power drops abruptly or temperature rises excessively, power can be restricted immediately.

The power controller determines the output voltage for power generation at the maximum power point by the determination method described above, sets the output voltage as the reference voltage, generates a control signal for controlling the output power of the fuel cell when the output voltage entered through the voltage input terminal is lower than the reference voltage, and outputs the control signal; so the use of the power controller enables the output voltage of the fuel cell to be always kept to or above the output voltage for power generation at the maximum power point. As a result, fuel cell power generation at a point exceeding the maximum power point never occurs. In addition, when the output power drops abruptly, power can be restricted immediately.

### BRIEF DESCRIPTION OF THE DRAWINGS

FIG. 1 is a schematic circuit diagram showing a model of a DC equivalent circuit in a fuel cell.

FIG. 2 is a characteristic chart representing changes in the output voltage of the direct methanol fuel cell according to changes in the temperature.

FIG. 3 is a characteristic chart representing changes in the output voltage of the direct methanol fuel cell according to changes in the air flow rate.

FIG. 4 shows an exemplary structure of a fuel cell control system according to a first embodiment of the present invention.

FIG. 5 shows another exemplary structure of the fuel cell control system according to the first embodiment of the present invention.

FIG. 6 shows an exemplary structure in which a function diagram of a control IC chip is added to the fuel cell control system according to the first embodiment.

FIG. 7 is a flowchart showing a control routine executed by the fuel cell control system according to the first embodiment of the present invention.

FIG. 8 shows the structure of a fuel cell control system according to a second embodiment of the present invention.

FIG. 9 is a flowchart showing a control routine executed by the fuel cell control system according to the second embodiment of the present invention.

FIG. 10 shows the structure of a fuel cell control system according to a third embodiment of the present invention.

FIG. 11 shows the structure of a fuel cell control system according to a fourth embodiment of the present invention.

FIG. 12 shows output characteristics of a polymer electrolyte fuel cell (PEFC) and direct methanol fuel cell (DMFC).

### DESCRIPTION OF THE PREFERRED EMBODIMENTS

First, the inventive method of determining the output voltage when the fuel cell generates power at the maximum power point will be described.

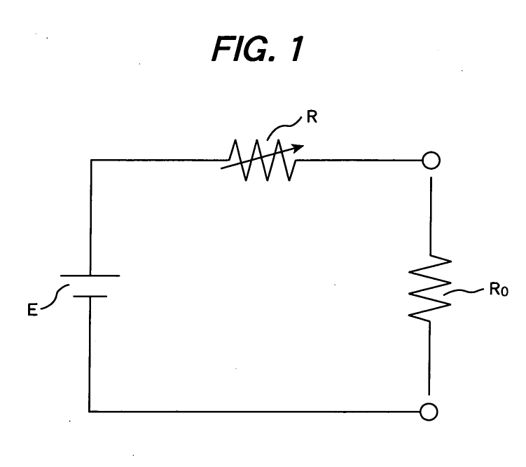

In general, a DC model of an equivalent circuit as shown in FIG. 1 can be used to represent the characteristic of a fuel cell. In FIG. 1, R is the internal resistance of the fuel cell, which changes according to the state of the fuel cell, and Ro is a resistive load.

The output power W in the DC model of the equivalent circuit is represented by equation (1).
W=E²/R×[(R/Ro+Ro/R)+2] (1)

where E is the voltage setting of the fuel cell.

The condition at which the output power W in equation (1) is maximized is R=Ro, as can be seen by differentiating (R/Ro+Ro/R) in equation (1) with respect to R. Since the output power W is maximized at R=Ro, therefore, the output voltage of the fuel cell (that is, the voltage across the terminals of the resistor Ro) is E/2, indicating that this value is the condition for the constant maximum power point regardless of the type of fuel cell and the power generation state. That is, when the output voltage of the fuel cell is 50% of the voltage setting, the output power at that time is the maximum power point. If the voltage setting E is determined and the output power is controlled so that the output voltage of the fuel cell becomes half the voltage setting E, the fuel cell can generate power at the maximum power point. The output power may be controlled by, for example, controlling the output current or the number of cells used for power generation.

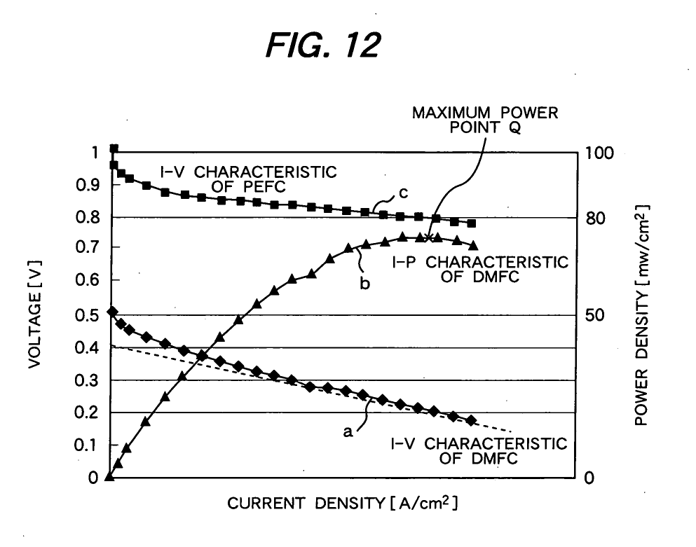

The voltage setting E can be obtained from the current-voltage characteristic of the fuel cell as described below. The characteristic curve “a” in FIG. 12, for example, is approximated by the straight approximating line, indicated by the dashed line, within a range excluding an area in which the output voltage changes abruptly when the output current (current density) is nearly zero, and an extrapolated voltage is determined on the extension line of the approximating line at an output current of zero, as the voltage setting E. Therefore, 50% of extrapolated voltage is the output voltage when the fuel cell generates power at the maximum power point.

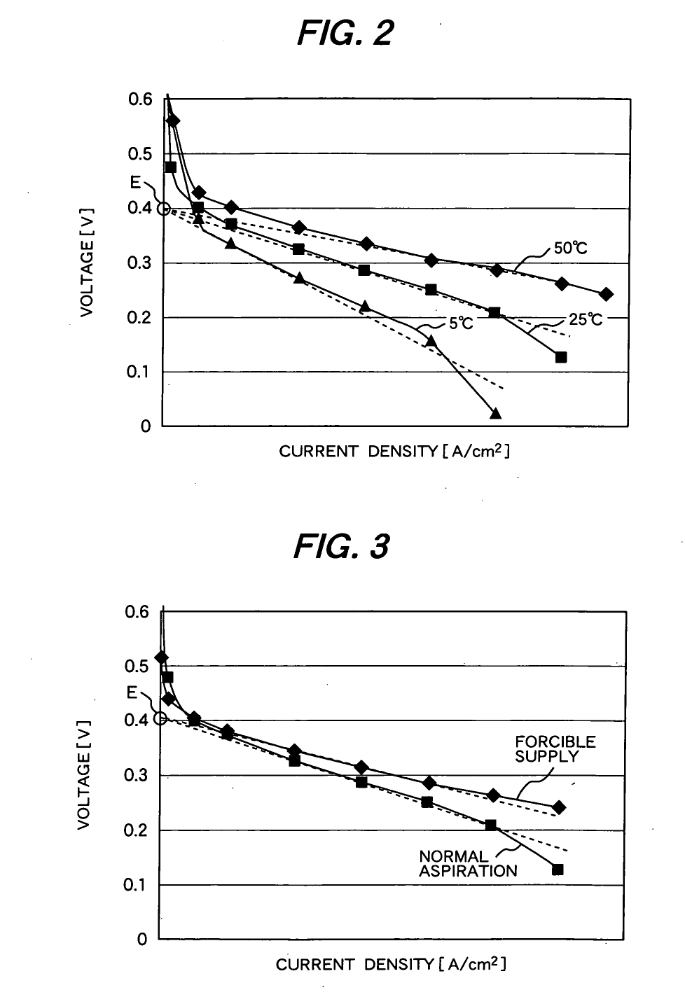

FIG. 2 is a characteristic chart representing the current-voltage characteristic of the direct methanol fuel cell at different temperatures with the current density (A/cm²) on the horizontal axis and the voltage (V) on the vertical axis.

As shown in FIG. 2, the direct methanol fuel cell has a voltage output characteristic such that the output voltage decreases as the output current increases and that when the output current remains unchanged, the output voltage decreases as the temperature drops. When the characteristic curves at the different temperatures are approximated by the straight approximating lines indicated by the dashed lines, as with the characteristic curve “a” in FIG. 12, the extrapolated voltages on the respective extension lines at an output current of zero are each 0.41 V. This means that the extrapolated voltage remains unchanged even when the temperature changes.

FIG. 3 is a characteristic chart representing the current-voltage characteristic of the direct methanol fuel cell at a constant temperature in forcible supply and normal aspiration.

As shown in FIG. 3, in normal aspiration in which a flow of air is negligibly slow, the output voltage of the fuel cell is lower than in forcible supply. When the characteristic curves are approximated by the approximating lines indicated by the dashed lines as described above, however, the extrapolated voltages on the respective extension lines at an output current of zero are each 0.41 V.

In summary, in the DC model of the equivalent circuit shown in FIG. 1, the same voltage setting can be used regardless of the power generation state of the fuel cell such as temperature. If an extrapolated voltage of the fuel cell is measured in advance and 50% of the extrapolated voltage is set as a target voltage to control the output voltage of the fuel cell, the fuel cell can always generate power at the maximum output point regardless of the power generation state of the fuel cell. If 50% of the extrapolated voltage is set as the minimum value to control the output voltage, the output power can be kept to or below the maximum power point during power generation by the fuel cell.

The approximating line used to obtain an extrapolated voltage need not be a straight line; a curved line may be used for approximation.

### First Embodiment

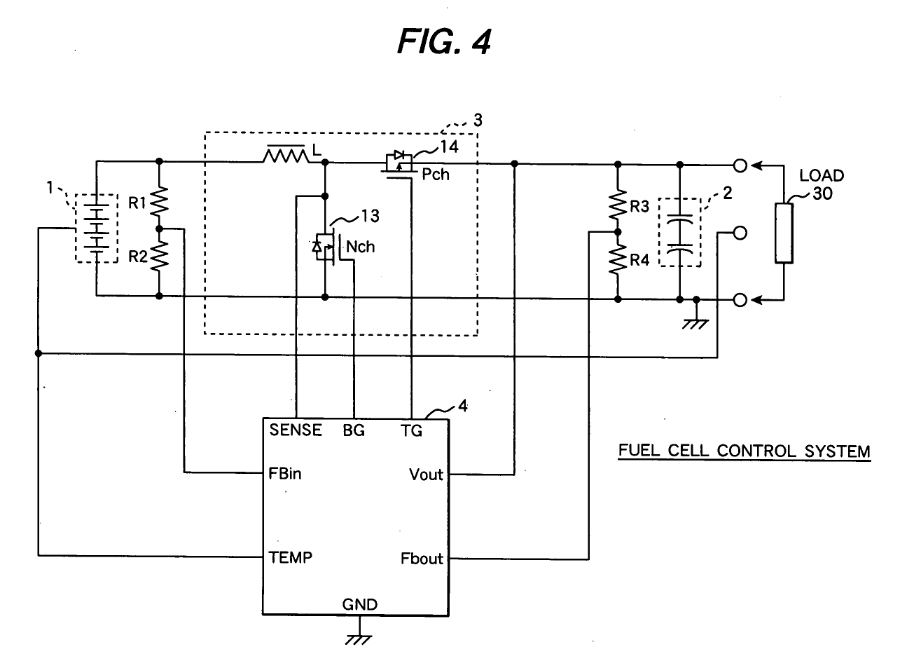

FIG. 4 shows an exemplary structure of a fuel cell control system according to a first embodiment of the present invention. The fuel cell control system mainly comprises a fuel cell 1, an electric double layer capacitor (EDLC) 2, which is a storage means, a circuit section 3, which is a step-up or step-down converter, and a control IC chip (power controller) 4 that performs switching control for the circuit section 3. The fuel cell control system is used in a mobile electronic apparatus. The fuel cell 1 is a direct methanol fuel cell.

In the fuel cell control system, the dielectric strength of the electric double layer capacitor 2 used as the storage means is 2.3 V to 3.3 V per cell. When two cells are connected in series as shown in FIG. 4, the dielectric strength is 4.6 V or higher, so the electric double layer capacitor 2 can be used in mobile telephones, personal digital assistants (PDAs), digital still cameras, multi-media players, and other electronic apparatus that operate with a conventional one-cell lithium-ion battery or two-cell nickel-hydride (NiMH) battery. For notebook computers and other applications that use a multi-cell lithium-ion battery, an electric double layer capacitor 2 comprising two to four cells may be used instead of a two-cell lithium-ion battery and an electric double layer capacitor 2 comprising three to five cells may be used instead of a three-cell lithium-ion battery. As the storage means, a secondary cell such as a lithium-ion battery may of course be used instead of the electric double layer capacitor 2.

Power demanded of a load 30 may be larger than the maximum power retrievable from the fuel cell 1. When the electric double layer capacitor 2 is provided as the storage means for the output of the fuel cell 1 as shown in FIG. 4, the electric double layer capacitor 2 can compensate for the insufficient power. When the fuel cell 1 falls into a temporarily deteriorated condition or the load 30, which requires power, is a mobile telephone or other pulse load, the electric double layer capacitor 2 can supply power for the insufficiency. With an application that uses many pulse loads, an electrical energy storing means such as an electric double layer capacitor having a superior discharge characteristic is preferably used to improve efficiency.

In this embodiment, a direct methanol fuel cell is used as the fuel cell 1, but a polymer electrolyte fuel cell or another type of fuel cell may be used. Although the fuel cell 1 in FIG. 4 uses four cells, more cells may be used to improve the efficiency of the circuit section 3.

The circuit section 3 is a synchronous rectification step-up converter that uses an N-channel power metal oxide semiconductor field effect transistor (MOSFET) 13 and P-channel power MOSFET 14. In this type of step-up converter, the energy of the fuel cell 1 is stored in the inductance L in the switching cycle when the N-channel power MOSFET 13 is turned on, and the energy of the fuel cell 1 and the energy stored in the inductance L are stored in the electric double layer capacitor 2 together in the switching cycle when the P-channel power MOSFET 14 is turned on. Accordingly, the voltage stored in the electric double layer capacitor 2 is higher than the output voltage of the fuel cell 1, that is, the electric double layer capacitor 2 is boosted.

The control IC chip 4 has at least eight terminals: voltage input terminal FBin to which voltage is supplied from the fuel cell 1, temperature terminal TEMP for obtaining a fuel cell temperature, stored voltage terminal Fbout for obtaining the voltage of the electric double layer capacitor 2, terminal Vout for obtaining the output voltage of the circuit section 3, terminal SENSE for obtaining a switching current, control terminal TG for the P-channel power MOSFET 14, control terminal BG for the N-channel power MOSFET 13, and ground terminal GND. In addition to the above eight terminals, an ON/OFF terminal for turning on and off the IC chip, loop compensation terminal, and the like may of course be provided as necessary. The control IC chip 4 will be described in detail later.

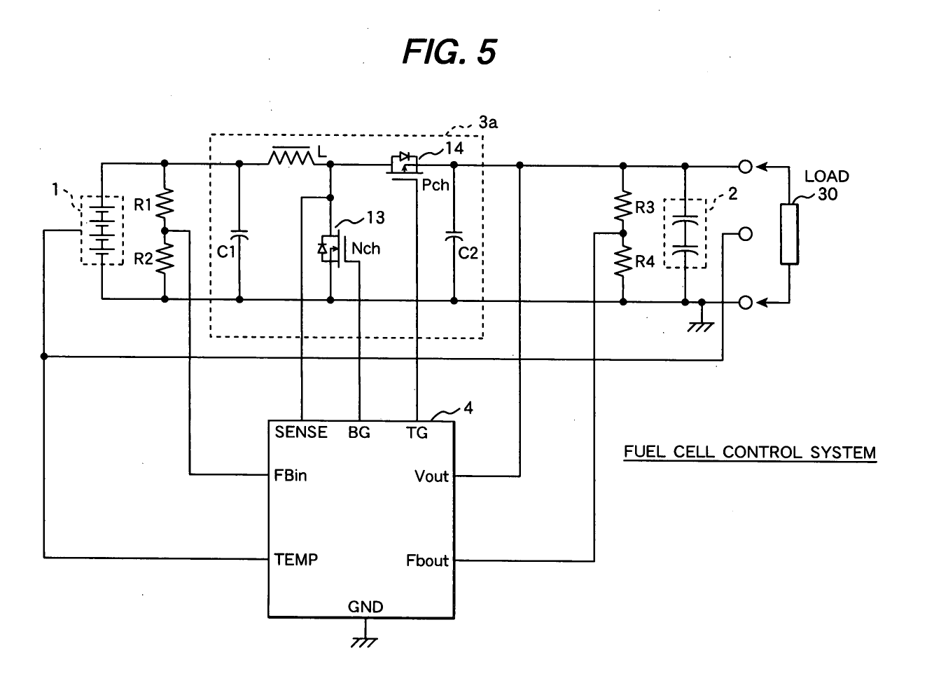

FIG. 5 shows another exemplary structure of the fuel cell control system according to the first embodiment of the present invention. The structure of the fuel cell control system shown in FIG. 5 differs from the structure of the fuel cell control system shown in FIG. 4 in that a capacitor C1 used for smoothing purposes and an identical capacitor C2 used for smoothing purposes are added to the input side of the circuit section 3a and output side, respectively. Addition of the capacitor C1 assures stable operation for the control IC chip 4 even when the fuel cell's output voltage to be supplied to the voltage input terminal FBin varies excessively. Similarly, addition of the capacitor C2 assures stable operation for the control IC chip 4 even when the voltage of the electric double layer capacitor 2 to be supplied to the stored voltage terminal Fbout or the voltage to be supplied to the terminal Vout for obtaining the output voltage varies excessively.

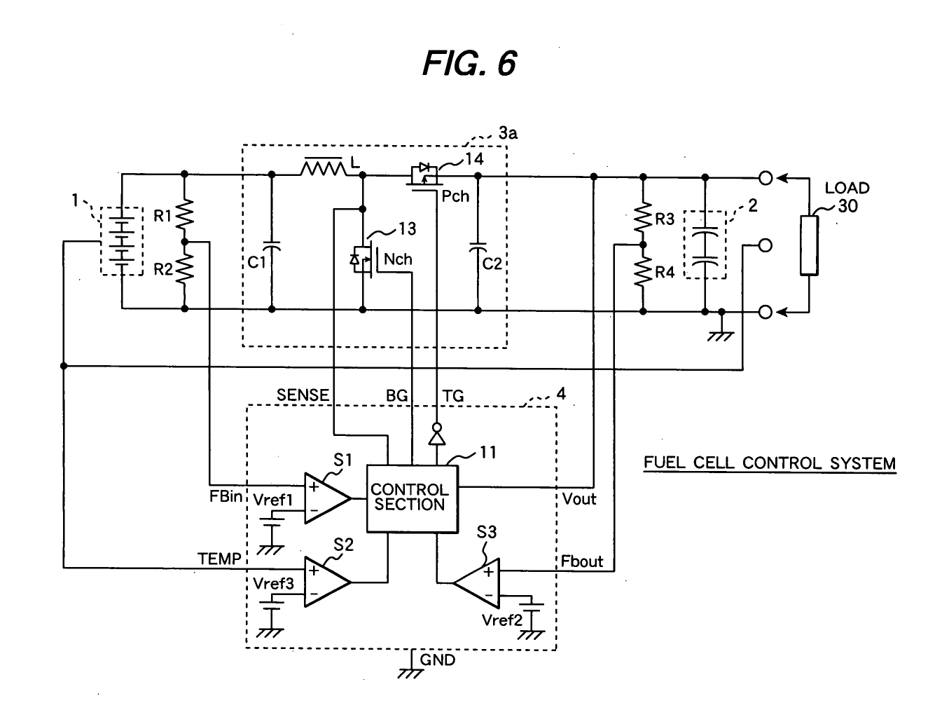

Next, the operation of the fuel cell control system will be described with reference to FIG. 6.

In FIG. 6, a functional structure of the IC chip is added to the fuel, cell control system in FIG. 5. The functions of the IC chip 4 will be described in detail below.

The control IC chip 4 mainly comprises differential amplifiers S1, S2, and S3 and a control section 11. A first feature of its functions is processing at the voltage input terminal FBin. Specifically, in the control IC chip 4, the voltage input terminal FBin receives a fuel cell detection voltage V, which is obtained by dividing the voltage of the fuel cell 1 by resistors R1 and R2, and then input to the differential amplifier S1; the voltage is compared with the first reference voltage Vref1 by the differential amplifier S1, and the differential voltage is supplied to the control section 11.

The first reference voltage Vref1 is set based on the extrapolated voltage obtained by the above method of determining a maximum power point, according to the dividing ratio of the resistors R1 and R2. That is, the first reference voltage Vref1 is set so that when the output voltage of the fuel cell falls to or below 50% of the extrapolated voltage, the differential amplifier S1 is inverted.

Since a direct methanol fuel cell is used in this embodiment, the extrapolated voltage is 0.41 V as indicated in FIGS. 2, 3, and 12.

The output voltage of the fuel cell 1 is divided by the resistors R1 and R2 and then input to the voltage input terminal FBin as the detection voltage V, as described above. When the detection voltage V becomes higher than the first reference voltage Vref1 (that is, the output voltage of the fuel cell 1 reaches 50% or more of the extrapolated voltage), the control section 11 performs control for the circuit section 3, as is usually done, by increasing the duty ratio of the normal pulse width modulation (PWM) to increase the current to be retrieved from the fuel cell 1. When the detection voltage V falls to or below the first reference voltage Vref1 (that is, the output voltage of the fuel cell 1 falls below 50% of the extrapolated voltage, the control section 11 lowers the duty ratio of PWM to lower the current to be retrieved from the fuel cell 1.

This enables the fuel cell 1 to always generate power at the maximum power point. As a result, power generation is not performed above the maximum power point, preventing the poles from being deteriorated due to output power insufficiency caused by lowered power generation efficiency.

The PWM duty ratio control described above is contrary to ordinary constant-voltage control; the control section 11 always traces the maximum power point by performing the above control and controls power generation by the fuel cell 1.

Accordingly, even if the output power lowers abruptly for some reason, for example, when the flow rate of the gas in the air pole lowers or carbon dioxide, water, or another product resulting from a reaction clogs, and thus current cannot be retrieved, the current is limited immediately. This also suppresses occurrence of products and causes the fuel cell 1 to recover the normal power generation state.

Next, an example of setting the resistor R1 and resistor R2 that constitute a detection circuit for detecting the output voltage of the fuel cell 1.

In this example, it is assumed that the first reference voltage Vref1 in the control IC chip 4 is 0.6 V and the fuel cell 1 is a four-cell stack and produces a maximum power point voltage of 0.84 V. In this case, the ratio of the resistance R1 to the resistance R2 can be set to 0.24:0.6. When the first reference voltage Vref1 is 1.2 V and the maximum power point voltage of the fuel cell 1 is 2.0 V, the resistance of the resistor R1 can be set to 0.8 kΩ and the resistance of the resistor R2 to 1.2 kΩ. That is, the resistance ratio of the resistor R1 to the resistor R2 can be determined by a proportional apportionment of the maximum power point voltage to the first reference voltage Vref1. In other words, the divided voltage ratio of the resistor R1 to the resistor R2 can be determined according to the voltage at the maximum power point and the first reference voltage Vref1.

Accordingly, even when the number of cells of the fuel cell 1 or the voltage at the maximum power point changes, if the divided voltage ratio of the resistor R1 to the resistor R2 is changed, the same control IC chip 4 can be used for a fuel cell stack that has a different number of cells or produces a different maximum power point voltage per cell.

The first reference voltage Vref1 may be set to 0.6 V or lower. When many cells are used, the first reference voltage Vref1 may be set to a high voltage such as 1.2 V. The fuel cell 1 is a direct methanol fuel cell as described above, so when the output current comes close to zero, the voltage rises abruptly. If the output voltage exceeds the dielectric strength of the capacitor C1 or the like, the life of the fuel cell 1 is affected. Care must be taken so that the current of the fuel cell 1 does not fall to zero. When the resistor R1 and resistor R2 are adjusted so that the total resistance of R1 and R2 is set to a value (from several kilohms to several hundred ohms, for example) that enables a current of several milliamperes to always flow from the fuel cell 1, a voltage rise as described above can be prevented.

A second feature of the functions of the control IC chip 4 shown in FIG. 6 is processing at the stored voltage terminal Fbout. Processing is performed for the voltage of the electric double layer capacitor 2. A structure as in feedback of the output voltage in an ordinary DC/DC converter is used. The second reference voltage Vref2 may be set to, for example, 0.6 V or 1.2 V depending on the number of electric double layer capacitors 2. Of course, the same voltage as the first reference voltage Vref1 or a voltage different from the first reference voltage Vref1 may be set by changing the divided voltage ratio of the resistor R3 to the resistor R4.

In the electric double layer capacitor 2 on the output side, the output detection voltage V divided by the resistor R3 and resistor R4 is input to the differential amplifier S3 through the stored voltage terminal Fbout and then compared here with the second reference voltage Vref2. The differential voltage is input to the control section 11. When the output detection voltage V is lower than the second reference voltage Vref2 by a prescribed value or more, which indicates that the electric double layer capacitor 2 is not fully charged, the control section 11 controls the PWM duty ratio so that the maximum power point is traced for power generation. When the output detection voltage V comes close to the second reference voltage Vref2, the control section 11 limits the PWM duty ratio. Specifically, when the voltage of the electric double layer capacitor 2 rises, the PWM duty ratio is decreased; when the output voltage lowers, the PWM duty ratio is increased. PWM can also be controlled by providing an upper limit for the output voltage. When the output detection voltage V comes close to the second reference voltage Vref2, PWM duty ratio control may be implemented by switching from control by tracing the maximum power point to ordinary step-up converter operation. By the processing described above, the voltage of the electric double layer capacitor 2, that is, the amount of charge, can be kept constant.

A third feature of the functions of the control IC chip 4 shown in FIG. 6 is processing at the temperature terminal TEMP. Input to the terminal TEMP is information about temperature of the fuel cell 1. The temperature information is obtained by, for example, a thermistor or temperature IC chip (not shown).

The temperature voltage V indicating the value of the detected temperature of the fuel cell 1 is input to the differential amplifier S2 and then compared here with the third reference voltage Vref 3. The differential voltage is input to the control section 11. The third reference voltage Vref3 may be set to, for example, 0.6 V or 1.2 V depending on the number of cells of the fuel cell 1. Of course, the same voltage as the first reference voltage Vref1 may be set by providing a resistor used for dividing the voltage or a voltage different from the first reference voltage Vref1 may be set.

When the temperature voltage V is lower than the third reference voltage Vref3 (that is, when the detected temperature of the fuel cell 1 is lower than the setting), the control section 11 performs control as usual so that power is generated at the maximum power point. When the temperature voltage V is higher than the third reference voltage Vref3 (that is, when the detected temperature of the fuel cell 1 is higher than the setting), the control section 11 limits the PWM duty ratio. Specifically, when the detected temperature of the fuel cell 1 is higher the setting, control for limiting the PWM duty ratio takes precedence over control for tracing the maximum power.

Since control for limiting the current to be retrieved from the fuel cell 1 is performed, as described above, as the temperature of the fuel cell 1 rises, the temperature of the fuel cell 1 can be kept constant. When 45° C. is set as a maximum allowable temperature, for example, it is possible to prevent the temperature of the fuel cell 1 from going to a point above 45° C. at which a user may be burnt.

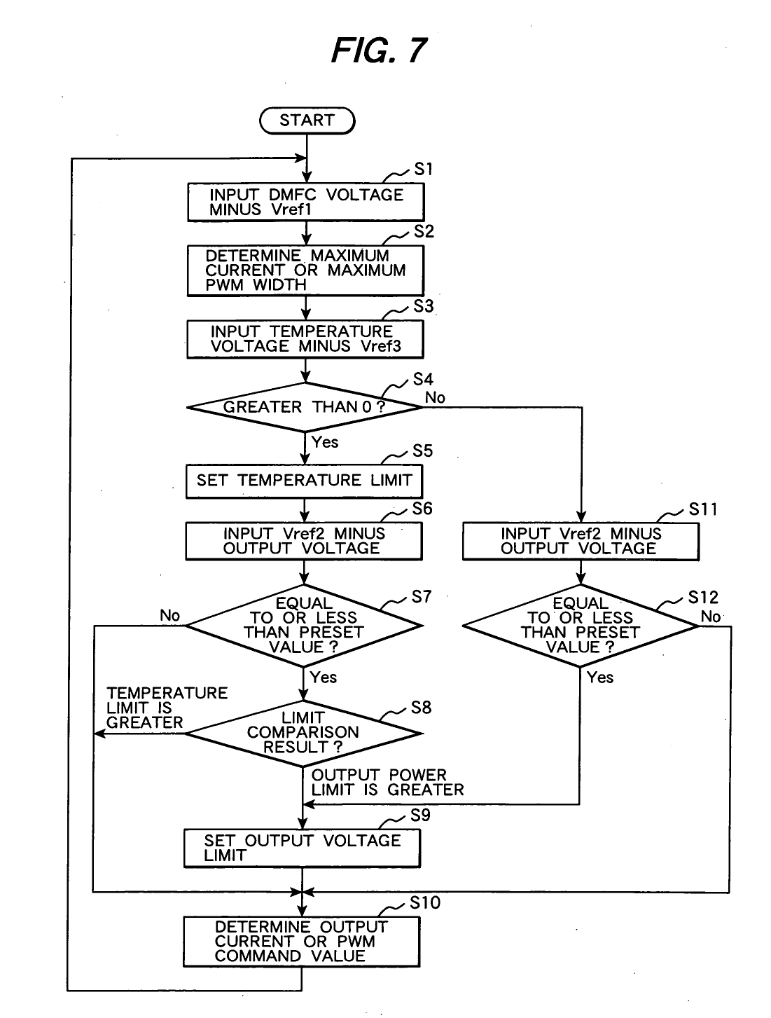

FIG. 7 is a flowchart showing a control routine executed by the fuel cell control system according to the first embodiment of the present invention.

Next, the flow of the flowchart in FIG. 7 will be described with reference to structural layout diagram of the fuel cell control system in FIG. 6. In FIG. 7, the control section 11 receives a differential voltage between the first reference voltage Vref1 and the output voltage of the fuel cell 1 that is divided by the resistor R1 and resistor R2 (step S1), and determines the maximum current or maximum PWM width according to the differential voltage (step S2). The control section 11 then receives a differential voltage between the temperature voltage V and third reference voltage Vref3 (step S3), and determines whether the difference voltage between the temperature voltage V and third reference voltage Vref3 is greater than 0 (step S4). If the difference voltage between the temperature voltage V and third reference voltage Vref3 is greater than 0 (if a Yes result is produced in step S4), which indicates that the temperature of the fuel cell 1 is higher than the preset value, the duty ratio of PWM is limited to suppress the temperature from being raised (to set a limit) (step S5).

Next, the control section 11 receives a differential voltage between the second reference voltage Vref2 and output voltage (step S6), and determines whether the differential voltage between the second reference voltage Vref2 and the output voltage of the circuit section 3a that is divided by the resistor R3 and resistor R4 is equal to or lower than the setting (step S7). If the differential voltage between the second reference voltage Vref2 and the output voltage of the circuit section 3a that is divided by the resistor R3 and resistor R4 is equal to or lower than the setting (if a Yes result is produced in step S7), limitation comparison (priority comparison) for determining whether the output power limitation or temperature limitation is prioritized is performed by comparing the differential temperature voltage and differential output voltage (step S8). If the output power limitation is greater (that is, the output power limit is prioritized), an output voltage limit is set (step S9), and a command value for the output current limit or PWM duty is determined (step S10). If the temperature limitation is greater in step S8 (that is, the temperature limitation is prioritized), a command value for the output current or PWM duty ratio is determined according to the condition of the temperature limit (step S10).

If the differential voltage between the temperature voltage and third reference voltage Vref3 is 0 V or lower (if a No result is produced) in step S4, which indicates that the temperature of the fuel cell 1 is low, the control section 11 receives a differential voltage between the second referential voltage Vref2 and output voltage (step S11), and determines whether the differential voltage between the second reference voltage Vref2 and the output voltage is equal to or lower than the setting (step S12). If the differential voltage between the second reference voltage Vref2 and the output voltage is equal to or lower than the setting (if a Yes result is produced in step S12), an output voltage limit is set (step S9), and a command value for the output current or PWM duty ratio is determined (step S10). If the differential voltage between the second reference voltage Vref2 and the output voltage exceeds the setting (if a No result is produced in step S12), a command value for the output current or PWM duty ratio is determined according to the setting (step S10). If the differential voltage between the second reference voltage Vref2 and the output voltage exceeds the setting (if a No result is produced) in step S7, a command value for the output current or PWM duty ratio is determined according to the setting (step S10).

As indicated by the control routine in FIG. 7, when the control section 11 in the control IC chip 4 operates in a current mode, the maximum power point can be traced by determining the maximum switching current, which is fed back from the SENSE terminal, from three pieces of feedback information, (that is, fuel cell voltage information, output voltage information, and fuel cell temperature information). Alternatively, instead of using the current mode, the PWM width can be of course changed to trace the maximum power point. If temperature information indicating a high fuel cell temperature or output voltage information indicating a low output voltage is input, control to forcibly limit the PWM duty ratio is performed by overriding maximum power tracing control based on the fuel cell voltage information.

### Second Embodiment

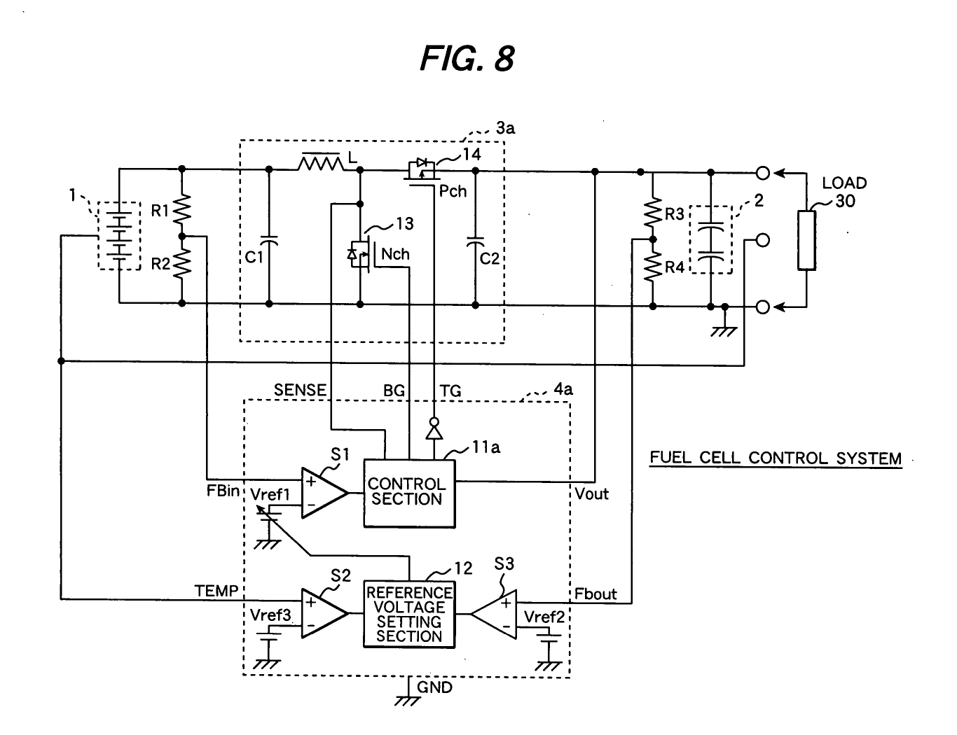

FIG. 8 shows the structure of a fuel cell control system according to a second embodiment of the present invention. The fuel cell control system uses a control IC chip 4a, the internal structure of which differs from that of the IC chip 4 in the fuel cell control system according to the first embodiment shown in FIG. 6. The structures of the circuit section 3a and other parts are the same as in the fuel cell control system shown in FIG. 6.

The control IC chip 4a comprises a control section 11a and reference voltage setting section 12. The output voltage of the circuit section 3a is divided by the resistor R3 and resistor R4, input to the stored voltage terminal Fbout, and then compared with the second reference voltage Vref2 by the differential amplifier S3. The differential voltage (referred to below as the output voltage difference) is output to a terminal of the reference voltage setting section 12. The temperature voltage of the fuel cell 1 is input from the temperature terminal TEMP and then compared with the third reference voltage Vref3 by the differential amplifier S2. The differential voltage (referred to below as the temperature voltage difference) is input to the other terminal of the reference voltage setting section 12. After these two pieces of feedback information, which are the output voltage difference and temperature voltage difference, are input to the reference voltage setting section 12, it changes the first reference voltage Vref1, which is the reference voltage for the output voltage of the fuel cell, according to the feedback information. The control section 11a controls the PWM duty ratio of the circuit section 3a according to the difference obtained from the difference amplifier S1.

Specifically, as exemplified in the first embodiment, a voltage of 0.6 V corresponding to the maximum power point voltage is set as the minimum value of the first reference voltage Vref1, and the current to be retrieved from the fuel cell 1 is limited by increasing the value of the first reference voltage Vref1 when at least either of the following conditions occurs; one is that the output voltage comes close to the target value, and the other is that the temperature voltage of the fuel cell 1 exceeds the setting. Three types of control, that is, maximum power point tracing control, constant output voltage control, and temperature limitation control, can thus be implemented by changing the target voltage (the first reference voltage Vref1) of the fuel cell 1 according to at least either of the output voltage condition and temperature voltage condition. If the control section 11a for controlling the PWM duty ratio and the reference voltage setting section 12 are provided separately, the control section 11a can use the existing control system (that is, the control IC chip 4 shown in FIG. 6) without alteration.

Next, flow of control by the IC chip 4a will be described with reference to the flowchart.

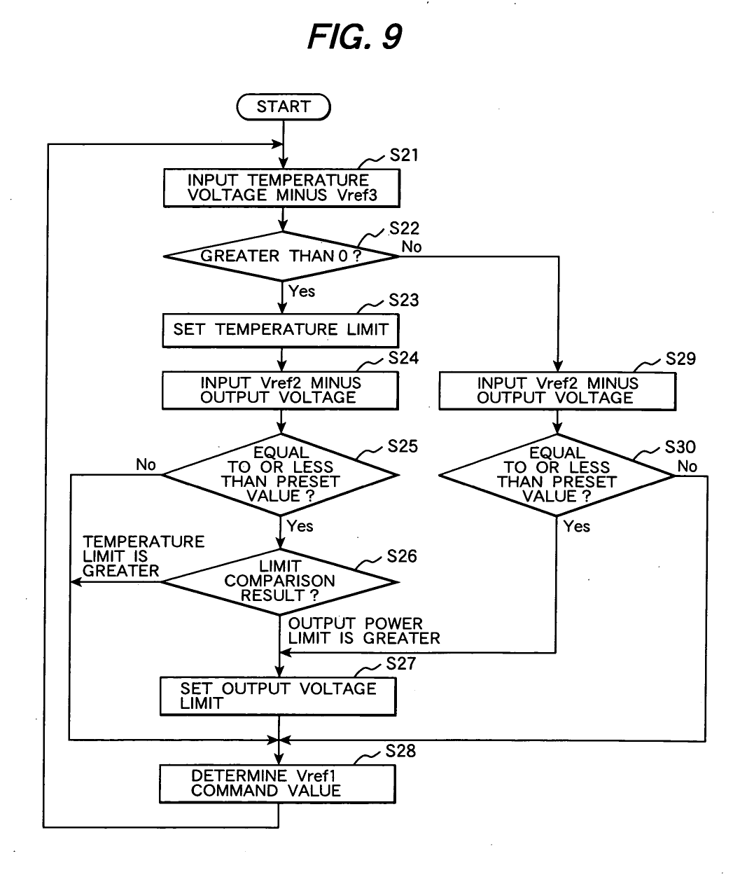

FIG. 9 is a flowchart showing a control routine executed by the fuel cell control system according to the second embodiment of the present invention.

In FIG. 9, the reference voltage setting section 12 receives a differential voltage between the temperature voltage and third referential voltage Vref3 from the differential amplifier S2 (step S21), and determines whether the difference voltage between the temperature voltage and third reference voltage Vref3 is greater than 0 (step S22). If the difference voltage between the temperature voltage and third reference voltage Vref3 is greater than 0 (if a Yes result is produced in step S22), which indicates that the temperature of the fuel cell 1 is higher than the preset value, the duty ratio of PWM is limited to limit the temperature (step S23).

The reference voltage setting section 12 then receives a differential voltage between the second referential voltage Vref2 and the output voltage of the electric double layer capacitor 2 from the differential amplifier S3 (step S24), and determines whether the difference voltage between the second reference voltage Vref2 and output voltage is equal to or smaller than the setting (step S25). If the differential voltage between the second reference voltage Vref2 and the output voltage is equal to or lower than the setting (if a Yes result is produced in step S25), limitation comparison for determining whether the output power limitation or temperature limitation is prioritized is performed (step S26). If the output power limitation is greater (that is, the output power limitation is prioritized), an output power limit is set (step S27), and a command value for the first reference voltage Vref1 is determined (step S28). If the temperature limitation is greater in step S26, a command value for the first reference voltage Vref1 is determined according to the condition of the temperature limit (step S28).

If the differential voltage between the temperature voltage and third reference voltage Vref3 is 0 V or lower (if a No result is produced) in step S22, the reference voltage setting section 12 receives a differential voltage between the second referential voltage Vref2 and output voltage (step S29), and determines whether the differential voltage between the second reference voltage Vref2 and the output voltage is equal to or lower than the setting (step S30). If the differential voltage between the second reference voltage Vref2 and the output voltage is equal to or lower than the setting (if a Yes result is produced in step S30), an output voltage limit is set (step S27), and a command value for the first reference voltage Vref1 is determined (step S28). If the differential voltage between the second reference voltage Vref2 and the output voltage exceeds the setting (if a No result is produced) in step S30, a command value for the first reference voltage Vref1 is determined according to the setting (step S28). If the differential voltage between the second reference voltage Vref2 and the output voltage exceeds the setting (a No result is produced) in step S25, a command value for the first reference voltage Vref1 is determined according to the setting.

As indicated by the control routine in FIG. 9, when neither the output voltage nor the temperature voltage is limited, the first reference voltage Vref1 is set to the minimum voltage of 0.6 V or the like because the maximum power point is targeted. When only the output voltage is limited, the Vref1 becomes higher than 0.6 V or the like according to the limited value, and the current retrieved from the fuel cell 1 is reduced, suppressing the voltage of the electric double layer capacitor 2 from being raised. When only the temperature voltage is limited, the Verf1 becomes higher than 0.6 V or the like according to the limited value, and the current retrieved from the fuel cell 1 is reduced, suppressing the temperature of the fuel cell 1 from being raised.

When the output voltage and temperature voltage are both limited, both limited values are compared. The Vref1 becomes higher than 0.6 V or the like according to the larger limited value, and the current retrieved from the fuel cell 1 is reduced, suppressing both the voltage of the electric double layer capacitor 2 and the temperature of the fuel cell 1 from being raised.

### Third Embodiment

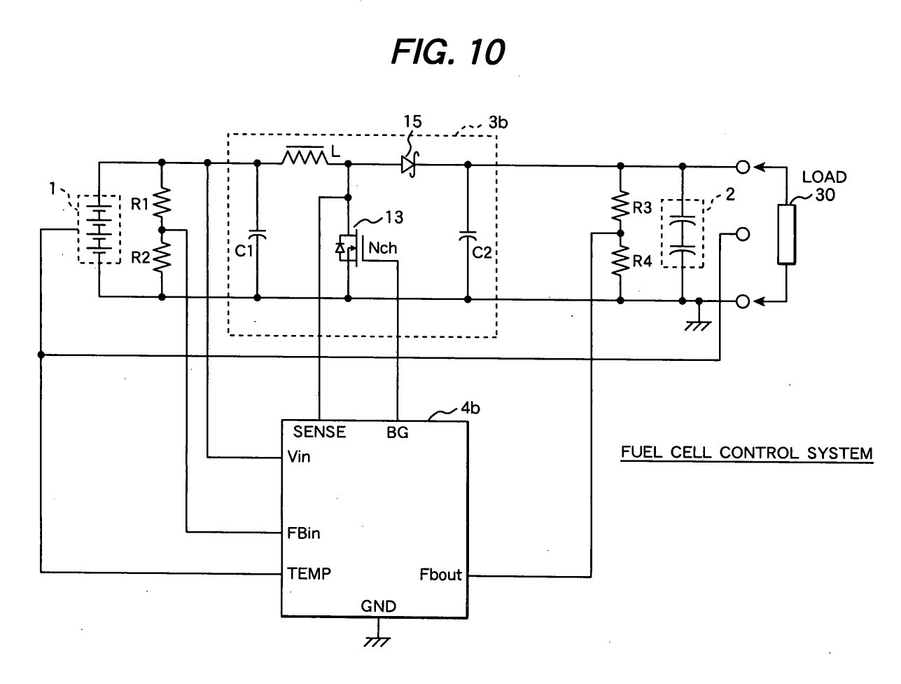

FIG. 10 shows the structure of a fuel cell control system according to a third embodiment of the present invention. The fuel cell control system according to the third embodiment shown in FIG. 10 differs from the fuel cell control systems according to the first and second embodiments in that the circuit section 3b is a step-up chopper circuit using a Schottky barrier diode 15 rather than being of the synchronous rectification type. Specifically, in the circuit section 3b in FIG. 10, the Schottky barrier diode 15 is substituted by the P-channel power MOSFET 14 in the circuit section 3a in FIG. 6. This structure is more useful for increasing the voltage at the output end than the structure according to the first embodiment in FIG. 6 and the structure according to the second embodiment in FIG. 8.

The control IC chip 4b according to the third embodiment shown in FIG. 10 will be described in detail. Unlike the control IC chip 4 according to the first embodiment shown in FIGS. 4 and 6 and the control IC chip 4a according to the second embodiment shown in FIG. 8, the control IC chip 4b according to the third embodiment lacks a control terminal TG used to control the P-channel power MOSFET 14 and uses a terminal Vin for obtaining power instead of the terminal Vout for obtaining an output voltage. In FIG. 10, the terminal Vin for obtaining power is connected to the input side so that a low terminal dielectric strength is allowed. If the output voltage is low, for example 20 V or lower, the terminal Vin may be connected to the output side. Either the structure of the control IC chip 4 according to the first embodiment shown in FIG. 6 or the structure of the control IC chip 4a according to the second embodiment shown in FIG. 8 may be used as the internal structure of the control IC chip 4b.

In the third embodiment, the dielectric strength of the electric double layer capacitor 2a used as the storage means is 2.3 V to 3.3 V per cell. When four cells are used as shown in FIG. 10, therefore, the electric double layer capacitor 2a can be used in notebook computers and other electronic apparatus that operate with a conventional lithium-ion battery using two or three cells. As an alternate storage means substituted for the electric double layer capacitor 2a, a secondary cell such as a lithium-ion battery may of course be used.

### Fourth Embodiment

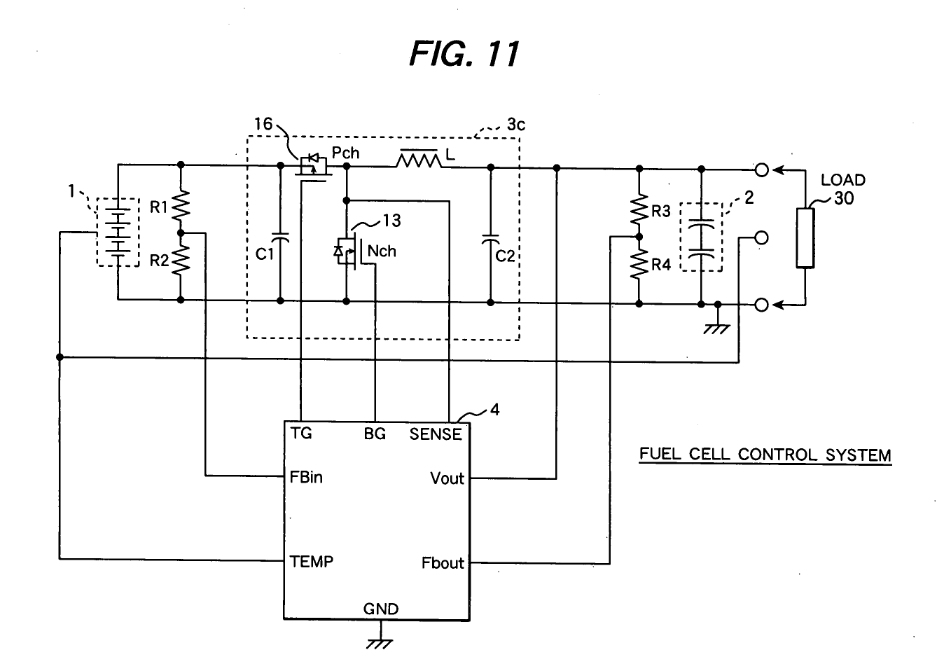

FIG. 11 shows the structure of a fuel cell control system according to a fourth embodiment of the present invention. The fuel cell control system according to the fourth embodiment shown in FIG. 11 is an example in which a step-down chopper is used as the circuit section 3c. Since the step-down chopper is structured as the circuit section 3c, it can provide for load voltages lower than the voltage of the fuel cell 1. Specifically, when the N-channel power MOSFET 16 is turned on and the N-channel power MOSFET 13 is turned off in the circuit section 3c in FIG. 11, current from the fuel cell 1 passes through the inductance L to the load 30. When the N-channel power MOSFET 16 is turned off and the N-channel power MOSFET 13 is turned on, the energy stored in the inductance L is cycled to the load 30. A voltage lower than the voltage of the fuel cell 1 is thus supplied to the load 30.

In the fourth embodiment shown in FIG. 11, the dielectric strength of the electric double layer capacitor 2b used as the storage means is 2.3 V to 3.3 V per cell. When the electric double layer capacitor 2b uses one cell as shown in FIG. 11, therefore, it can be used in electronic apparatus that operate on a low voltage such as 1.8 V. As an alternate storage means substituted for the electric double layer capacitor 2b, a secondary cell such as a lithium-ion battery or Ni-hydrogen battery may of course be used. In FIG. 11, the N-channel power MOSFET 13 may be replaced with a Schottky barrier diode. Either the structure of the control IC chip 4 according to the first embodiment shown in FIG. 6 or the structure of the control IC chip 4a according to the second embodiment shown in FIG. 8 may be used as the internal structure of the control IC chip 4.

Exemplary fuel cell control systems according to the four embodiments have been described. Some of these embodiments may be combined according to the usage in the mobile electronic apparatus.

In the embodiments, a direct methanol fuel cell is used as the power supply of the mobile electronic apparatus. However, the power supply is not limited to a direct methanol fuel cell; a polymer electrolyte fuel cell, for example, may be used. When a polymer electrolyte fuel cell or another fuel cell other than a direct methanol fuel cell is used, the maximum power point voltage varies. If a maximum power point voltage is determined by the method according to any one of the embodiments described above, however, power can be generated by tracing the maximum power point in the same way as described above. Even a solar cell and another cell that has a maximum power point for load current variations can be used for determining a maximum power point voltage and performing maximum power point tracing control.

What is claimed is:

1. A method for determining a maximum power point voltage of a fuel cell, wherein a characteristic curve representing a current-voltage characteristic of the fuel cell is approximated by a prescribed approximating line within a range excluding an area in which an output voltage changes abruptly when an output current is nearly zero, an extrapolated voltage is obtained on an extension line of the prescribed approximating line at an output current of zero, and an output voltage when the fuel cell generates power at a maxim power point is determined as the maximum power point voltage.

2. The method for determining a maximum power point voltage of a fuel cell according to claim 1, wherein the output voltage when power is generated at the maximum power point is 50% of the extrapolated voltage.

3. The method for determining a maximum power point voltage of a fuel cell according to claim 1, wherein the fuel cell is a direct methanol fuel cell.

4. A fuel cell control system that has a reference voltage generating means for generating a reference voltage and a control means for controlling an output voltage of a fuel cell so that when the output voltage of the fuel cell is lower than the reference voltage, the output voltage is increased, wherein:
the reference voltage generated by the reference voltage generating means is set to a voltage equal to or higher than a maximum power point voltage when the fuel cell generates power at a maximum power point, the maximum power point voltage being assumed to be a minimum reference voltage; and
a characteristic curve representing a current-voltage characteristic of the fuel cell is approximated by a prescribed approximating line within a range excluding an area in which an output voltage changes abruptly when an output current is nearly zero, an extrapolated voltage is obtained on an extension line of the prescribed approximating line at an output current of zero, and then the maximum power point voltage is determined from the extrapolated voltage.

5. The fuel cell control system according to claim 4, wherein the control means compares a temperature detection value of the fuel cell with a preset temperature value and, when the temperature detection value of the fuel cell exceeds the preset temperature value, controls the output power of the fuel cell so that the temperature of fuel cell does not rise.

6. The fuel cell control system according to claim 5, wherein the control mean is capable of controlling the output voltage of the fuel cell according to a difference between the temperature detection value of the fuel cell and the preset temperature value; the reference voltage is compensated so that the reference voltage is increased as the difference becomes smaller.

7. The fuel control system according to any one of claims 4, wherein:
a storage means which is charged by the fuel cell is connected to the fuel cell; and
the control means compares an input voltage of the storage means with a voltage setting and, when the input voltage of the storage means exceeds the voltage setting, limits the output power of the fuel cell.

8. The fuel control system according to claim 7, wherein, to limit the output power of the fuel cell, the control means obtains a difference between the voltage of the storage means and the voltage setting and compensates the reference voltage according to the difference, that is, so that the reference voltage is increased as the difference becomes smaller.

9. The fuel control system according to claim 7, wherein the control means keeps the input voltage of the storage means constant by compensating the reference voltage.

10. A power controller used in a fuel cell control system, comprising at least:
a voltage input terminal being capable of receiving an output voltage of a fuel cell;
a control terminal for outputting a control signal to a control end of a power regulating means that regulates the output power of the fuel cell;
a reference voltage generating source for generating a reference voltage; and
a control signal generating means for comparing the output voltage of the fuel cell that is received at the voltage input terminal with the reference voltage generated by the reference voltage generating source, creating a control signal to limit the output power of the fuel cell so as to increase the output voltage of the fuel cell when the output voltage is lower than the reference voltage, and outputting the control signal to the control terminal; wherein:
the reference voltage generated by the reference voltage generating source is set to a voltage equal to or higher than a maximum power point voltage when the fuel cell generates power at a maximum power point, the maximum power point voltage being assumed to be a minimum reference voltage; and
a characteristic curve representing a current-voltage characteristic of the fuel cell is approximated by a prescribed approximating line within a range excluding an area in which an output voltage changes abruptly when an output current is nearly zero, an extrapolated voltage is obtained on an extension line of the prescribed approximating line at an output current of zero, and then the maximum power point voltage is determined from the extrapolated voltage.

11. The power controller according to claim 10, further comprising a temperature terminal to which a temperature detection value of the fuel cell is capable of being input, wherein the control signal generating means compares the temperature detection value of the fuel cell with a preset temperature value and, when the temperature detection value of the fuel cell exceeds the preset temperature value, generates the control signal so that the output power of the fuel cell decreases.

12. The power controller according to claim 10, wherein the control signal generating means obtains a difference between the temperature detection value of the fuel cell and the preset temperature value, and compensates the reference voltage according to the difference, that is, so that the reference voltage is increased as the difference becomes smaller.

13. The power controller according to any one of claims 9, further comprising a storage terminal from which a voltage of the storage means charged by the fuel cell is input, wherein the control signal generating means generates the control signal according to a difference between a preset voltage and the voltage of the storage means, which is input from the storage terminal, and generates the control signal according to the difference.

14. The power controller according to any one of claims 10, further comprising a storage terminal from which a voltage of the storage means charged by the fuel cell is input, wherein the control signal generating means obtains a difference between the voltage in the storage means and a preset voltage, and compensates the reference voltage according to the difference, that is, so that the reference voltage is increased as the difference becomes smaller.
